(19) United States
(12) Patent Application Publication
(10) Pub. No.: US 2026/0139437 A1
(43) Pub. Date: May 21, 2026

(54) AN INTERMEDIATE COMPOSITION

(71) Applicant: KEMIRA OYJ, Helsinki (FI)

(72) Inventors: Asko KARPPI, Espoo (FI); Judith TARAZONA, Villatuerta (Navarra) (ES); Xavier DE SEQUERA, Barcelona (ES); Perttu HEISKA, Helsinki (FI); Eric PADOVANI, Strasbourg (FR)

(21) Appl. No.: 18/705,882

(22) PCT Filed: Oct. 28, 2022
(86) PCT No.: PCT/FI2022/050708

§ 371 Date: Apr. 29, 2024

(30) Foreign Application Priority Data
Oct. 28, 2021 (FI) 20216118

(51) Int. Cl. D21H 21/20; C08G 73/02; D21H 17/55

(52) U.S. Cl. CPC D21H 21/20; C08G 73/0286; D21H 17/55

(57) ABSTRACT

The present invention relates to an intermediate composition in form of an aqueous solution having a pH value ≤6 for manufacture of polyamidoamine epihalohydrin resin. The intermediate composition comprises a polyamidoamine derivative having an average molecular weight of <150 000 g/mol with covalently bound pendant halohydrin groups, wherein the polyamidoamine derivative comprises 5-95 mol-%, preferably 7-90 mol-% of pendant halohydrin groups. The intermediate composition further comprises a total amount of 1,3-dihalo-2-propanol and 3-halopropyleneglycol less than 3500 ppm, calculated from the total dry weight of the intermediate composition.

### CROSS REFERENCES

This application is a U.S. national stage application of international PCT application PCT/F12022/050708 filed on Oct. 28, 2022 and claiming priority to Finnish national application number 20216118 filed on Oct. 28, 2021.

### FILED OF INVENTION

The present invention relates to an intermediate composition in form of an aqueous solution suitable for manufacture of polyamidoamine epihalohydrin resins according to the preamble of the enclosed independent claim.

### BACKGROUND

Polymer resins are used to manufacture of paper, board and the like in order to improve the wet strength of the produced fibre webs. Polyamidoamine epihalohydrin (PAE) resins are commonly used in industry for wet strength purposes. Conventionally, PAE resins are produced in a multistage process, for example from diethylenetriamine, adipic acid and epichlorohydrin. In final stages of the resin production the pendant chlorohydrin groups of the polyamidoamine derivative are transformed into azetidinium groups at an elevated temperature. Finally the resin is crosslinked through these azetidinium groups to the desired molecular weight.

Stability of polyamidoamine epihalohydrin resins is an important aspect in their manufacture and use. After their manufacture, the crosslinking reaction in the resin continues, which leads to increased molecular weight and increased viscosity of the resin. If the molecular weight of the resin, and thus its viscosity, increases too much, the resin becomes unworkable. Due to these phenomena, the PAE resins usually have a limited storage stability. Uncontrolled viscosity increase of the PAE resin can be reduced by adjusting the pH of the resin to acidic level around pH 2.5-3.5. Acidic pH leads to slight decrease of viscosity of the resin during storage.

Stability of polyamidoamine epihalohydrin resins is influenced also by the temperature. PAE resins are relatively stable at temperatures of 25° C. or below, but they become unstable at higher temperatures. Reduced stability can be seen as significant decrease in resin viscosity, i.e. decrease in molecular size of the resin, and decrease in charge density of the resin. Viscosity decreases over 40-60% and charge density decreases about 50% after one month storage are fully possible. These negative phenomena can be observed already at temperatures around 35° C., which are already quite typical during summertime storage and may become even more common in future due to the climate change. PAE resins are subjected to elevated temperatures also in mill environments when they are stored for prolonged times, for example due to process delays or unplanned production stops at paper and board mills. In combination, the decreased viscosity and charge density deteriorate the wet strength performance of PAE resin. Due to these phenomena, the PAE resins usually have a limited storage stability.

One solution to this problem has been the transfer of the manufacture of the PAE resins as close as possible to the final use location. However, due to the occupational and environmental safety issues, especially associated with the handling of epichlorohydrin, there are limitations to the applicability of this approach.

An aspect of PAE resins relates to their content of residual compounds originating from epihalohydrin and formed during the resin manufacture as undesired by-products. Common residual compounds formed as by-products during PAE manufacture with epichlorohydrin are, for example, dichloropropanol (DCP) and chloropropanediol (CPD). The final resin may also contain residual unreacted epihalohydrin, usually epichlorohydrin (ECH). The allowed amount of these residual compounds originating from epihalohydrin and/or formed as by-products is limited in the final resin by regulatory provisions. For example, EU Ecolabel criteria for Graphic paper and Tissue paper (2019), defines that the allowed total DCP, CPD and ECH amount must be below 3500 mg/kg of total resin solids. Consequently, there is an interest to reduce the amount of these residual compounds in produced polyamidoamine epihalohydrin resin.

### SUMMARY

An object of this invention is to minimise or possibly even eliminate the disadvantages existing in the prior art.

An object is also to provide an intermediate composition which enables production of polyamidoamine halohydrin resins which is stable and which contains low amount of undesired residual compounds.

A further object of this invention is also to provide an intermediate composition, which is especially suitable for on-site manufacture of polyamidoamine halohydrin resins.

A yet further object of this invention is to provide an intermediate composition, which shows good stability and reactivity, even after storage at elevated temperature.

These objects are attained with the invention having the characteristics presented below in the characterising parts of the independent claims. Some preferable embodiments are disclosed in the dependent claims.

The features recited in the dependent claims and the embodiments in the description are mutually freely combinable unless otherwise explicitly stated.

The exemplary embodiments presented in this text and their advantages relate by applicable parts to all aspects of the invention, even though this is not always separately mentioned.

A typical intermediate composition according to the present invention in form of an aqueous solution having a pH value ≤6 for manufacture of polyamidoamine epihalohydrin resin, which intermediate composition comprises polyamidoamine derivative having an average molecular weight of <150 000 g/mol with covalently bound pendant halohydrin groups, wherein the polyamidoamine derivative comprises 5-95 mol-%, preferably 7-90 mol-% of pendant halohydrin groups, and wherein the intermediate composition comprises a total amount of 1,3-dihalo-2-propanol (DCP) and 3-halopropyleneglycol (CPD) less than 3500 ppm, calculated from the total dry weight of the intermediate composition.

Typical use of the intermediate composition according to the present invention is for manufacture of polyamidoamine epihalohydrin resin.

A typical method according to the present invention for preparing an intermediate composition for manufacture of polyamidoamine epihalohydrin resin according to the invention comprises
obtaining a polyamidoamine prepolymer by a condensation reaction of a dibasic carboxylic acid and a polyamine, such as a polyalkylenepolyamine,
reacting the obtained polyamidoamine with epihalohydrin at a temperature of <30° C. in a presence of water to obtain the intermediate composition comprising a polyamidoamine derivative having an average molecular weight of <150 000 g/mol with covalently bound pendant halohydrin groups, wherein the polyamidoamine derivative comprises 5-95 mol-%, preferably 7-90 mol-% of pendant halohydrin groups, and
optionally purifying the intermediate composition, e.g. by precipitation or filtration.

### DETAILED DESCRIPTION OF THE INVENTION

The gist of the present invention is to provide a specific intermediate composition for production of polyamidoamine epihalohydrin resins. Now it has been surprisingly found that an acidic intermediate composition, where the polyamidoamine derivative has a weight average molecular weight <150 000 and comprises 5-95 mol-% of pendant halohydrin groups, preferably chlorohydrin groups, provides unexpected advantages in manufacture of polyamidoamine epihalohydrin resins. The intermediate composition is especially suitable for transport as it has shown improved stability, even at elevated temperatures, as well as high polymer content. This enables its use for on-site or near-site production for final polyamidoamine epihalohydrin resins. The on-site or near-site production provides fresh resins with maximal reactivity and good wet strength response. In general, the present intermediate composition offers a versatile base for the production of polyamidoamine epihalohydrin resins in more efficient manner.

Furthermore, as the intermediate composition according to the present invention is especially suitable for on-site or near-site production, it provides the advantage for the polyamidoamine epihalohydrin resin production that the resin content is not limited to a certain concentration level, for example due to the transportation and/or storage costs. Conventionally, the concentration of the produced polyamidoamine epihalohydrin is a result of a compromise between the resin concentration and the desired wet strength response. It is known that high resin concentration, e.g. 25 weight-%, produces slightly decreased wet strength response for the final paper or board than a resin concentration around 15-20 weight-%. However, the transportation and storage costs, based on dry resin content, for the higher concentration are significantly smaller. When used on-site or near-site production the present intermediate composition allows the adjustment of the polyamidoamine epihalohydrin concentration to the optimal level in regard of the wet strength response, as the transportation and storage costs are not decisive in on-site or near-site production.

In the present context, polyamidoamine derivative is understood as a polymer obtained by a reaction between polyamidoamine and epihalohydrin, preferably epichlorohydrin. The polyamidoamine derivative is thus polyamidoamine epihalohydrin with pendant groups originating from epihalohydrin, i.e. pendant halohydrin groups, as well as optional pendant azetidinium groups.

The intermediate composition of the present invention is in form of an aqueous solution and it has a pH value ≤6. The acidic pH of the intermediate composition provides desired stability, prevents the premature crosslinking of the polyamidoamine derivative and makes the intermediate composition suitable for transport and storage. For example, the intermediate composition may be prepared at a chemical factory and transported to a site of use, where the final crosslinking is initiated in an on-site process by increasing the pH of the intermediate composition to a pH value >7 at an elevated temperature. According to one preferable embodiment the intermediate composition may have a pH value ≤5.5, preferably ≤5, more preferably ≤4.5, even more preferably ≤4.0. The pH of the intermediate composition may be, for example, in a range of 2.5-6.0 or 2.5-5.5, preferably 3.0-5.0, sometimes even more preferably 3.0-4.5 or 3.2-4.2. Too low pH value, e.g. pH <2.5, is not advisable as it may lead to degradation of polyamidoamine derivative structure, for example during transport and/or storage. The pH of the intermediate composition may be adjusted acidic by a suitable acid, such as hydrochloric acid, sulphuric acid, methanesulphonic acid, nitric acid, formic acid, phosphoric acid, acetic acid, or any of their combinations. Preferably at least one strong acid, for example sulphuric acid, is used.

The intermediate composition may have a polyamidoamine derivative content of 15-75 weight-% or 20-75 weight-%, preferably 20-70 weight-%, more preferably 25-65 weight-%, even more preferably 30-60 weight-%, calculated from the total weight of the intermediate composition. In addition to the polyamidoamine derivative, the intermediate composition comprises at least water, i.e. the intermediate composition is an aqueous composition in form of solution. The polymer content in the intermediate composition is preferably as high as possible, which makes the transport of the intermediate composition more cost effective. In practice the main components of the intermediate composition are polyamidoamine derivative and water, which two components make up at least 85 weight-%, preferably at least 90 weight-%, more preferably at least 95 weight-%, of the total weight of the intermediate composition.

The intermediate composition may have a viscosity at least 10 mPas, preferably in a range of 10-1000 mPas, more preferably 50-500 mPas, sometimes 100-400 mPas. The viscosity is measured as described in the experimental section. The viscosity of the intermediate composition is dependent on its polymer content. The viscosity of the intermediate composition allows its transfer by pumps or similar devices.

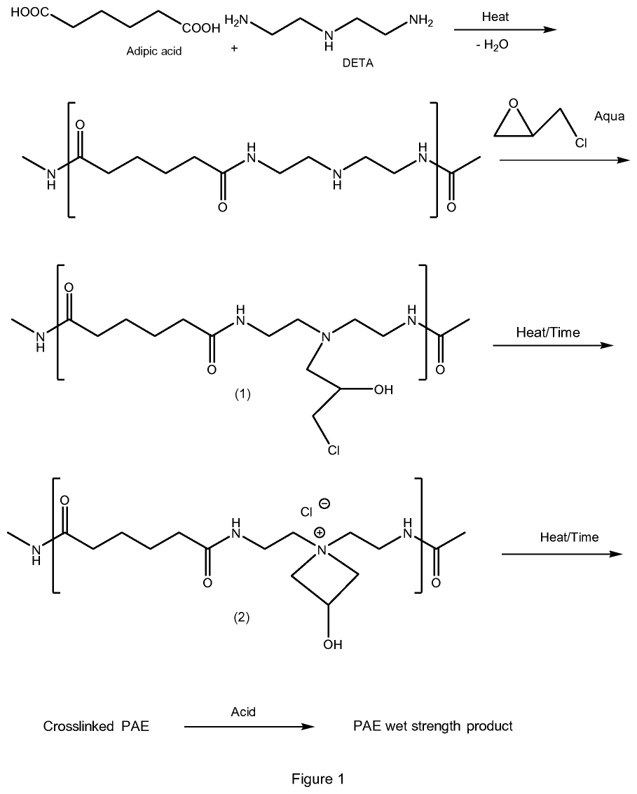

FIG. 1 shows how the intermediate composition comprising polyamidoamine derivative is obtainable by reacting polyamidoamine and epihalohydrin, preferably epichlorohydrin.

Polyamidoamine used for the manufacturing the intermediate composition, also called as polyamidoamine prepolymer, may be obtained by a condensation reaction of dibasic carboxylic acid and polyamine, such as a polyalkylenepolyamine, as shown in FIG. 1. FIG. 1 demonstrates the reaction by using adipic acid and diethylenetriamine, but other dibasic carboxylic acids and polyamines, as disclosed below, may be used as well. The condensation reaction between the dibasic carboxylic acid and polyamine may be performed at a temperature in a range from 120-170° C., preferably 130-150° C., at atmospheric pressure. The condensation reaction produces water as by-product, which may be removed by distillation.

The dibasic carboxylic acid suitable for producing the starting polyamidoamine may be selected from a group comprising adipic acid, glutaric acid, oxalic acid, malonic acid, succinic acid, itaconic acid, azelaic acid, as well as their derivatives such as esters, half-esters, acid halides and anhydrides, and any of their mixtures. For example, a suitable derivative of dibasic carboxylic acid may be dimethyl glutarate, diethyl glutarate, dimethyl adipate, diethyl adipate, dimethyl succinate and/or diethyl succinate. Polyamine for producing polyamidoamine prepolymer may be selected from a group comprising polyalkylenepolyamines, such as polyethylenepolyamine, polypropylenepolyamine, polybutylenepolyamine, polypentylenepolyamine, polyhexylenepolyamine and any of their mixtures, in particular diethylenetriamine, triethylenetetramine, tetraethylenepentamine, dipropylenetriamine, tripropylene-tetramine, pentaethylenehexamine, aminoethylpiperazine and any of their mixtures, bis(3-aminopropyl)amine, methylbis(3-aminopropyl)amine, ethylbis(3-aminopropyl)amine, N-(3-aminopropyl)tetramethylenediamine, N,N′-bis(3-aminopropyl)tetramethylenediamine, N,N-bis(2-aminoethyl)-ethylenediamine, diaminoethyl triaminoethylamine and piperazmethyl triethylenetetramine.

The molar ratio of dicarboxylic acid and polyamine, preferably polyalkylenepolyamine, such as diethylenetriamine, for forming the polyamidoamine may be from 1:0.95 to 1:1.1, preferably from 1:1 to 1:1.1, typically around 1:1.

The intermediate may be obtained by reacting the obtained polyamidoamine prepolymer with epihalohydrin, preferably epichlorohydrin, as shown in FIG. 1, at a temperature <30° C., preferably <25° C., more preferably <20° C., sometimes even <15° C. The temperature during the reaction of polyamidoamine with epihalohydrin may be in a range of 2-29° C., preferably 10-25° C., more preferably 16-20° C. The reaction is conducted in the presence of water. It has been observed that by lowering the reaction temperature to <30° C. during the reaction between the polyamidoamine and epihalohydrin, it is possible to significantly reduce the formation of residuals and by-product compounds originating from epihalohydrin, such as 1,3-dihalo-2-propanol (DCP) and 3-halopropyleneglycol (CPD). As the amount of epihalohydrin and residuals originating from epihalohydrin is minimised in the intermediate composition, the amount of these residuals in the final polyamidoamine epihalohydrin resin is also effectively reduced, making the final resin more efficient and safer to use, especially in on-site resin production. At the same time, the selected low reaction temperature guarantees the desired percentage of halohydrin groups for the polyamidoamine derivative.

The ratio of polyamidoamine prepolymer and epihalohydrin, in weight-%, may be from 66:34 to 70:30.

It is seen from FIG. 1 that the reaction between polyamidoamine and epihalohydrin results in polyamidoamine derivative according to formula (1). This polyamidoamine derivative of the intermediate composition, obtained after the reaction of the polyamidoamine and epihalohydrin, has covalently bound pendant halohydrin groups, and optional pendant azetidinium groups, connected to the polyamidoamine backbone. In the polyamidoamine derivative backbone, formed from the dicarboxylic acid and polyamine units, the pendant groups are mainly bound to the secondary amines of the polyamine units. An example of this is shown in FIG. 1, where the polyamidoamine derivative of formula (1) contains a pendant chlorohydrin group. One polyamidoamine derivative may naturally comprise more than one pendant group, and both halohydrin groups and azetidinium groups may be covalently bound to the same polyamidoamine derivative. Typically the polyamidoamine derivative comprises 5-95 mol-%, preferably 7-90 mol-% of pendant halohydrin groups, calculated from molar amount of polyamine units present in polyamidoamine derivative. The amount of pendant halohydrin groups can be determined by using ¹³C NMR method, for example as described in EP 1627006.

According to one preferable embodiment of the invention the intermediate composition comprises a polyamidoamine derivative, which may comprise 50 mol-%, preferably ≥75 mol-%, even more preferably ≥80 mol-% of pendant halohydrin groups, preferably chlorohydrin groups, calculated from molar amount of polyamine units present in polyamidoamine derivative. The polyamidoamine derivative may comprise 30-95 mol-%, preferably 35-90 mol-%, more preferably 40-80 mol-%, of pendant halohydrin groups, calculated from molar amount of polyamine units present in polyamidoamine derivative. It is possible, that the polyamidoamine derivative comprises 50-95 mol-%, preferably 75-90 mol-%, more preferably 80-90 mol-%, of pendant halohydrin groups, calculated from molar amount of polyamine units present in polyamidoamine derivative. This means that majority of the pendant groups in the polyamidoamine derivative are in form of halohydrin groups, preferably chlorohydrin groups. When most of the pendant groups in the polyamidoamine derivative are in form of halohydrin groups the stability of the intermediate composition is further improved, and the risk for premature crosslinking of the polyamidoamine derivative during transport and storage is minimised. When the intermediate composition is transported and/or stored at high temperatures, e.g. around 30-40° C., the halohydrin groups are slowly converted into azetidinium groups, while the pH of the intermediate composition is decreased. The decrease in pH simultaneously prevents gelling of the intermediate composition. In this manner it is possible to provide the intermediate composition with better heat resistance as well as charge stability, even during storage at high temperatures.

The polyamidoamine derivative preferably comprises <40 mol-%, preferably <30 mol-%, more preferably <25 mol-%, even more preferably <20 mol-%, of pendant azetidinium groups, calculated from molar amount of polyamine units present in polyamidoamine derivative. The polyamidoamine derivative may comprise 0-39 mol-%, preferably 1-30 mol-%, more preferably 1-25 mol-%, even more preferably 4-20 mol-%, of pendant azetidinium groups, calculated from molar amount of polyamine units present in polyamidoamine derivative. The high amount of halohydrin groups in the polyamidoamine derivative may be preferable, as the halohydrin groups provide resistance against hydrolysis, which improves the stability of the intermediate composition. As the stability of the intermediate composition improves, it can be stores at higher pH, which reduces the risk for decrease in molecular size, when stored at elevated temperature.

According to another embodiment of the present invention the polyamidoamine derivative in the intermediate composition may comprise 5-95 mol-%, preferably 10-93 mol-%, of pendant azetidinium groups. The polyamidoamine derivative may comprise, for example, 50-95 mol-%, preferably 60-93 mol-%, more preferably 65-90 mol-%, of pendant azetidinium groups, calculated from molar amount of polyamine units present in polyamidoamine derivative. According to this embodiment of the present invention the intermediate composition may be subjected to heating, as indicated in FIG. 1, which results in polyamidoamine derivative according to formula (2). The intermediate composition may be heated, for example, to a temperature in a range of 55-65° C. This transforms a part of the pendant halohydrin groups of the polyamidoamine derivative into azetidinium groups, ready to be crosslinked after pH increase of the intermediate composition. The transformation of halohydrin groups to azetidinium groups may also occur, at least to a certain degree, during a prolonged storage, at least in elevated temperatures. According to one embodiment, the polyamidoamine derivative may comprise 5-50 mol-%, preferably 7-40 mol-%, more preferably 10-35 mol-%, of pendant halohydrin groups, calculated from molar amount of polyamine units present in polyamidoamine derivative. Especially after prolonged storage, e.g. about 5 weeks or more at 20° C., or alternatively, about 1 week or more at 35° C., the polyamidoamine derivative of the intermediate composition may comprise 5-50 mol-%, preferably 7-40 mol-%, more preferably 10-35 mol-%, of pendant halohydrin groups.

The polyamidoamine derivative of the intermediate composition has a relatively low average molecular weight. The low average molecular weight indicates that the polyamidoamine derivative in the intermediate composition has not been subjected to crosslinking, at least in any extensive amount. Typically the polyamidoamine derivative in the intermediate composition has a weight average molecular weight of <150 000 g/mol. According to one embodiment of the invention the intermediate composition comprises a polyamidoamine derivative having the weight average molecular weight of <100 000 g/mol or <75 000 g/mol, preferably <50 000 g/mol, more preferably <35 000 g/mol, even more preferably <25 000 g/mol or <20 000 g/mol, sometimes even <10 000 g/mol. The weight average molecular weight of the polyamidoamine derivative may be 4000 g/mol or more, preferably 5000 g/mol or more. For example, the weight average molecular weight of the polyamidoamine derivative may be in a range of 4000-100 000 g/mol or 4000-75 000 g/mol, preferably 5000-50 000 g/mol, more preferably 5000-35 000 g/mol.

The weight average molecular weights for the present purposes are measured by using SEC/GPC determination with PEO (polyethyleneoxide) calibration as described in the following. The weight average molecular weight MW is determined by size-exclusion chromatography (SEC) using Agilent 1100 SE chromatography equipment with integrated pump, autosampler and degasser. Eluent is a buffer solution (0.3125 M CH₃COOH+0.3125 M CH₃COONa) with a flow rate of 0.5 ml/min at 35° C. Typical sample concentration is 2-4 mg/ml, with an injection volume of 50 μl. Ethylene glycol (1 mg/ml) is used as a flow marker. The used column set consists of three columns (one TSKgel PWXL guard column and two TSKgel GMPWXL columns). Refractive index detector by Agilent is used for detection (T=35° C.). Molecular weight is determined using conventional column calibration with poly(ethylene oxide)/poly(ethylene glycol) narrow molecular weight distribution standards (Polymer Standards Service).

According to one preferable embodiment of the present invention the polyamidoamine derivative of the intermediate composition is non-crosslinked.

The intermediate composition typically has a total amount of 1,3-dihalo-2-propanol (DCP), such as 1,3-dichloro-2-propanol, and 3-halopropyleneglycol (CPD), such as 3-chloropropyleneglycol, less than 3500 ppm, calculated from the total dry weight of the intermediate composition. According to one preferable embodiment the total amount of 1,3-dihalo-2-propanol (DCP) and 3-halopropyleneglycol (CPD) in the intermediate composition may be less than 2000 ppm, preferably less than 1000 ppm, more preferably less than 700 ppm, even more preferably less than 500 ppm, sometimes even less than 200 ppm or less than 100 ppm, calculated from the total dry weight of the intermediate composition. Preferably the total amount of 1,3-dihalo-2-propanol (DCP), such as 1,3-dichloro-2-propanol, and 3-halopropyleneglycol (CPD), such as 3-chloropropyleneglycol, is as small as possible. The total amount may be, for example, in a range of 0-3500 ppm or 0-2000 ppm, preferably 0-1000 ppm, more preferably 0-700 ppm, even more preferably 0-500 ppm, calculated from the total dry weight of the intermediate composition.

The intermediate composition further preferably comprises low amount of organic and inorganic salts, especially halogen salts, such as chloride salts. According to one embodiment of the invention the intermediate composition may have a halogen ion, especially chloride ion, content <5 weight-%, preferably <3.5 weight-%, more preferably <3.0 weight-%, even more preferably <2.5 weight-%, calculated from the total dry weight of the intermediate composition. For example, the intermediate composition may have a halogen ion, especially chloride ion, content in a range of 0-4.9 weight-%, preferably 0.1-3.4 weight-%, more preferably 0.1-2.9 weight-%, even more preferably 0.5-2.4 weight-%.

If deemed necessary, non-reacted epihalohydrin, by-products and residuals originating from epihalohydrin, as well as organic and inorganic salts, can be removed from the intermediate composition by using suitable purification methods. According to one embodiment of the invention the intermediate composition may be purified, e.g. by precipitation or filtration, such as membrane filtration, after the reaction of the polyamidoamine and epihalohydrin at a temperature <20° C. The intermediate composition may be purified, for example, by using nanofiltration or ultrafiltration. Nanofiltration uses membranes with pore size from 1 nm to less than 5 nm, and ultrafiltration uses membranes with pore size from 5 nm to 100 nm. It has been observed that the removal of non-reacted epihalohydrin, by-products and residuals is significantly improved, when the purification step is performed to the intermediate composition. It is assumed that the relatively low molecular weight of the polyamidoamine derivative, among other possible factors, makes the purification step easier to perform as well improves the purification results. After purification the total amount of epihalohydrin and residuals originating from epihalohydrin may be less than 2000 ppm, preferably less than 1000 ppm, more preferably less than 700 ppm, even more preferably less than 500 ppm, calculated from the total dry weight of the intermediate composition. Preferably, after purification the total amount of epihalohydrin and residuals originating from epihalohydrin may be <400 ppm, preferably <300 ppm, even <200 ppm, calculated from the total dry weight of the intermediate composition. For example, the total amount of epihalohydrin and residuals originating from epihalohydrin may be in a range of 5-400 ppm, preferably 10-300 ppm, sometimes even 20-200 ppm, calculated from the total dry weight of the intermediate composition.

### EXAMPLES

Some embodiments of the present invention are described in the following non-limiting examples.

### Equipment and Methods Used in Analysis

Dry solids content was determined by using Mettler Toledo HR73, at 150° C.

Viscosity was determined by using Brookfield LV DV1, equipped with small sample adapter, at 25° C., using spindle S18. The highest feasible rotation speed for the spindle was used.

pH was determined by using a calibrated pH-meter.

Charge density was determined at pH 9.5, adjusted with 10 weight-% aqueous NaOH solution, by charge titration using polyethylene sulfonate solution as titrant. Mütek PCD-03 was used for end point detection.

Chloride content was determined by potentiometric titration with Methrom 916 Ti-Touch titrator with I—Ag (Ref. 60470300) electrode and silver nitrate (0.1 N) as titrant. Before analysis, sample was diluted to about 2% concentration with deionized water. 100 ml of diluted solution was acidified with 3 ml 70% nitric acid and mixed for 1 min before titration.

ECH, DCP and CPD were determined by gas chromatography.

Molecular weights of the polymers were determined as described in the general part of the description.

### Comparative Example C1: Stability of Conventional Polyamidoamine Epichlorohydrin Wet Strength Polymer

A commercial polyamidoamine epichlorohydrin PAE product was obtained having following characteristics: dry content 21.5 weight-%, viscosity 88 cP (at 25° C.), pH 2.8, charge density 2.0 meg/g dry (at pH 9.5).

Stability of this PAE product was studied at three different pH values, pH 2.6, pH 2.8 and pH 3.0, and at two different temperatures, 23° C. and 35° C. pH of PAE product samples, 190 g each, were adjusted to desired pH, if needed, as indicated in Table 1. Samples were stored at 23° C. and at 35° C., but the actual viscosity values were determined at 25° C. and charge densities at pH 9.5, as indicated above.

Stability results at 23° C. are in Table 2a, stability results at 35° C. are in Table 2b.

TABLE 1
Adjustment of pH for PAE wet strength polymer stability test.

| | | pH | Amount of pH |
|---|---|---|---|
| | Sample | Adjustment | Adjustment Agent |
| Sample | pH | Agent | [g] |
| 1 | 2.6 | Sulfuric acid, 96% | 0.3 |
| 2 | 2.8 | No pH adjustment | — |
| 3 | 3.0 | NaOH, 32% | 0.8 |

TABLE 2a
Viscosity and charge stability of PAE wet strength polymer at 23° C.

| | Sample 1, pH 2.6 | | Sample 2, pH 2.8 | | Sample 3, pH 3.0 | |
|---|---|---|---|---|---|---|
| Storage | | Charge | | Charge | | Charge |
| Time | Viscosity | Density | Viscosity | Density | Viscosity | Density |
| [days] | [mPas] | [meq/g dry] | [mPas] | [meq/g dry] | [mPas] | [meq/g dry] |
| 0 | 88 | 2.0 | 88 | 2.0 | 86 | 2.1 |
| 9 | 67 | 1.9 | 73 | 1.9 | 77 | 1.9 |
| 15 | 60 | 1.9 | 67 | 1.9 | 73 | 1.9 |
| 20 | 55 | 1.9 | 64 | 1.9 | 70 | 1.9 |
| 27 | 50 | 1.7 | 58 | 1.7 | 66 | 1.8 |

TABLE 2b
Viscosity and charge stability of PAE wet strength polymer at 35° C.

| | Sample 1, pH 2.6 | | Sample 2, pH 2.8 | | Sample 3, pH 3.0 | |
|---|---|---|---|---|---|---|
| Storage | | Charge | | Charge | | Charge |
| Time | Viscosity | Density | Viscosity | Density, | Viscosity | Density |
| [days] | [mPas] | [meq/g dry] | [mPas] | meq/g dry | [mPas] | [meq/g dry] |
| 0 | 88 | 2.0 | 88 | 2.0 | 86 | 2.1 |
| 9 | 45 | 1.5 | 54 | 1.4 | 64 | 1.5 |
| 15 | 37 | 1.3 | 46 | 1.4 | 56 | 1.4 |
| 20 | 33 | 1.2 | 41 | 1.3 | 52 | 1.2 |
| 27 | 29 | 0.9 | 37 | 1.0 | 45 | 1.0 |

Results show that both viscosity and charge stability of the commercial polyamidoamine epichlorohydrin resin are decreasing when stored prolonged time at elevated temperature of 35° C., a common temperature as such during the summer months. It is obvious that a prolonged storage at an elevated temperature deteriorates performance of commercial PAE wet strength polymer.

### Example 1: Production of an Intermediate Composition Comprising Polyamidoamine Derivative

Polyamidoamine, S-PAIM, was obtained by a reaction between adipic acid and diethylene triamine DETA, molar ratio about 1:1. S-PAIM had a weight average molecular weight Mw about 5000 g/mol. S-PAIM was in form of aqueous solution, concentration 38 weight-%.

424 g of S-PAIM was reacted with 77 g of epichlorohydrin, ECH, at 20° C. for 24 h. The obtained solution comprised reaction product of S-PAIM and EHC, and was then acidified with 6 g of formic acid (conc. 85%) and 78 g of sulfuric acid (conc. 30%) to form the desired intermediate composition.

Characteristics of the intermediate composition are given in Table 3.

TABLE 3
Characteristics of the intermediate composition of Example 1.

| | |
|---|---|
| Dry content, weight-% | 45.2 |
| Viscosity, cP | 145 |
| pH | 3.7 |
| CI content, weight-% | 1.3 |
| Average molecular weight, g/mol | 5200 |
| Halohydrin group proportion, mol-% | 75 |
| DCP, mg/kg composition | 864 |
| CPD, mg/kg composition | 274 |
| ECH, mg/kg composition | 3 |
| Total DCP, CPD, ECH of | 2524 |
| dry material, mg/kg | |

### Example 2: Purification of Intermediate Composition

The intermediate composition of Example 1 was aged for 6 weeks. After aging 200 g of the intermediate composition was poured into 500 g of ethanol (conc. 99.5%) under 20 min time while stirring with magnetic stirrer at 350 rpm. The obtained mixture was stirred for 30 min. The formed precipitate was isolated by filtration through S&S 589 filter paper with vacuum.

The isolated precipitate was washed three times with 100 g ethanol (conc. 99.5%). The washing procedure included 30 min stirring in ethanol before the ethanol was removed by vacuum filtration. Then 200 g of aqueous ethanol (conc. 70%) was added to the washed precipitate, stirred for 60 min. 250 g of ethanol (conc. 99.5%) was added to this mixture and stirred for 60 min. The formed precipitate was isolated by filtration with vacuum. The filtrate was washed two times with 100 g of ethanol (99.5%), the washing procedure including 10 min stirring before ethanol was removed by vacuum filtration. Precipitates comprising polyamidoamine derivative and ethanol were combined, the total weight was 106.5 g.

The combined precipitates were dissolved in 213.5 g water. 215 g of this obtained solution and 100 g of water was mixed. Ethanol was removed with rotary evaporator treatment at 25 mbar vacuum, water bath temperature 28° C. The amount of the purified intermediate composition after rotary evaporator treatment was 221 g. Characteristics of the purified intermediate composition comprising polyamidoamine derivative are given in Table 4.

TABLE 4
Characteristics of the purified intermediate
composition of Example 2.

| | |
|---|---|
| Dry content, weight-% | 28.7 |
| Viscosity, cP | 23.6 |
| pH | 4.1 |
| CI content, weight-% | 0.6 |
| Average molecular weight, g/mol | 6350 |
| DCP, mg/kg composition | 0 |
| CPD, mg/kg composition | 19 |
| ECH, mg/kg composition | 0 |
| Total DCP, CPD, ECH of | 66 |
| dry material, mg/kg | |

### Example 3: Production of Low Residual Polyamidoamine Epichlorohydrin Resin

Low residual polyamidoamine epichlorohydrin resin was produced by using low residual intermediate composition prepared in Example 2 as a starting material. 139 g of the intermediate composition of Example 2 (polymer conc. 28.7 weight-%) and 61 g of water were dosed into a reactor to form a reaction mixture. 7.85 g of NaOH (50%) was dosed under stirring to increase the pH of the reaction mixture to pH 8.0. Reaction mixture temperature was increased gradually to 65° C. under 90 min time and the rection mixture was mixed at 65° C. for 60 min. Then reaction mixture was acidified with an addition of 1.4 g of formic acid and 0.5 g of sulfuric acid (30%). The obtained polyamidoamine epichlorohydrin resin was then cooled and analysed. Characteristics of the obtained polyamidoamine epichlorohydrin resin are given in Table 5.

TABLE 5
Characteristics of the polyamidoamine epichlorohydrin
resin prepared in Example 3.

| | |
|---|---|
| Polymer content, weight-% | 19.5 |
| Dry content, weight-% | 21.3 |
| Viscosity, cp (25° C.) | 131 |
| pH (21.6° C.) | 2.8 |
| Charge density, meq/g pol | 2.1 |
| Average molecular weight, g/mol | 365 900 |
| DCP, mg/kg composition | 0 |
| CPD, mg/kg composition | 13 |
| ECH, mg/kg composition | 0 |
| Total DCP, CPD, ECH of | 61 |
| dry material, mg/kg | |

Results in Table 5 show that a polyamidoamine epichlorohydrin resin which is suitable for use applications which require low amounts of residuals can be obtained by using the aged purified intermediate composition of the present invention.

### Example 4: Application Test

Wet strength performance of polyamidoamine epichlorohydrin resin, denoted EX.3 PAE, prepared in Example 3 was tested.

Used pulp comprised 50 weight-% of softwood of 50 weight-% hardwood. Pulp had pH value of 7 and SR value of 25. Pulp consistency was 0.5 weight-%. Test sheets were made in laboratory by using Rapid Köthen former, followed by resin curing at 120° C., for 20 min.

Properties for the test sheets were determined by using standard methods for grammage (ISO 536), tensile strength (ISO 1924-3), tensile index (ISO 1924-3) and wet tensile strength (ISO 3781:2011), all strength values measured in machine direction. As a reference were used a commercial polyamidoamine epichlorohydrin product CPAE (20 weight-%). Results are given in Table 6.

TABLE 6
Results of Example 4.

| | | | | | Wet | | |
|---|---|---|---|---|---|---|---|
| | PAE | | Tensile | Tensile | Tensile | Wet Tensile | Wet to |
| | Dosage** | Grammage | Strength | Index | Strength | Index | Dry |
| | [kg/t pulp] | [g/m²] | [kN/m] | [Nm/g] | [kN/m] | [Nm/g] | [%] |
| 0-test* | — | 82.5 | 5.1 | 61.6 | 0.2 | 1.8 | 3.0 |
| CPAE | 4.0 | 83.6 | 6.5 | 77.9 | 1.4 | 16.9 | 21.7 |
| (ref.) | | | | | | | |
| CPAE | 8.0 | 84.6 | 6.9 | 81.9 | 1.9 | 22.0 | 26.7 |
| (ref.) | | | | | | | |
| EX. 3 PAE | 4.0 | 83.8 | 6.8 | 80.6 | 1.4 | 17.0 | 21.1 |
| EX. 3 PAE | 8.0 | 83.1 | 7.2 | 86.4 | 1.9 | 22.9 | 26.5 |

*no wet strength resin
**given as dry resin

Results of Table 6 show that a good wet strength performance is obtained using polyamidoamine epichlorohydrin resin made from intermediate composition of Example 3. The strength results are at least similar, or even better than with a conventional polyamidoamine epichlorohydrin resin.

### Example 5: Production of Polyamidoamine Epichlorohydrin Resin from Fresh Intermediate Composition

An intermediate composition was made in the same manner and by using similar type of aqueous solution of polyamidoamine reacted with epichlorohydrin as in Example 1. After the reaction between polyamidoamine and epichlorohydrin the obtained solution had a dry content of 39 weight-%, viscosity 80 cP, pH 8.4, Cl content 0.8 weight-%.

500 g of this solution was acidified with 4 g formic acid (95%) and 66 g sulfuric acid (30%) to form an intermediate composition. Thus obtained intermediate composition had a dry content of 39 weight-%, polyamidoamine derivative content of 36 weight-%, pH 4.0, viscosity 60 cP, Cl content of 0.8 weight-%.

113 g of the intermediate composition and 87 g deionized water were mixed and 11 g NaOH (50%) was added under mixing. The mixture was heated to 65° C. within 1 hour and then mixed at 65° C. for 1.5 h. After this 1.5 g formic acid (85%) and 4 g sulfuric acid (30%) were added to the mixture, resulting a polyamidoamine epichlorohydrin resin.

Properties of this polyamidoamine epichlorohydrin resin, made from fresh intermediate composition, which was less than 1 week old, stored at 5° C., were compared to a commercial polyamidoamine epichlorohydrin wet strength resin. Results for the comparison are given in Table 7.

Results in Table 7 show that polyamidoamine epichlorohydrin resin made from the fresh intermediate composition has a practically equal charge density than the commercial PAE resin, when calculated to the polymer content of the resin. Dry content of polyamidoamine epichlorohydrin resin made from the fresh intermediate composition had a higher dry content than the commercial PAE resin, at the same polymer content, which was due to the neutralisation salt. It is further seen from Table 7 that the residual content of the resins is practically equal and both resins are EU Ecolabel compliant for Graphic paper and Tissue paper.

TABLE 7
Results of Example 5.

| | PAE Resin from Fresh | Commercial |
|---|---|---|
| | Intermediate | PAE Wet |
| | Composition | Strength Resin |
| PAE resin content, weight-% | 20 | 20 |
| Dry content, weight-% | 23 | 20 |
| Viscosity, cp (25° C.) | 118 | 93 |
| pH (21.6° C.) | 3.5 | 2.8 |
| Charge density, | 1.6 | 2.0 |
| meq/g dry material | | |
| Charge density, | 1.9 | 2.0 |
| meq/g polymer | | |
| DCP, mg/kg resin | 268 | 326 |
| CPD, mg/kg resin | 204 | 197 |
| ECH, mg/kg resin | 0 | 2 |
| Total DCP, CPD, ECH of | 2393 | 2586 |
| resin solids, mg/kg | | |

### Example 6. Stability of Intermediate Composition

A series of PAE intermediate compositions were made using similar type of aqueous solution of polyamidoamine reacted with epichlorohydrin as in Example 1. After the reaction between polyamidoamine and epichlorohydrin the obtained solution had a dry content of 47 weight-%, viscosity 300 cP, pH 8.3, Cl content 1.3 weight-%.

500 g samples of this solution were taken and acidified with formic acid (95%) and sulfuric acid (30%) to form intermediate compositions with different pH value. Characteristics of the intermediate compositions are given in Table 8.

Intermediate composition samples were stored at 25° C. and viscosity and chloride content was determined as function of storage time. Results are shown in Table 9.

It can be seen from results in Table 9 that viscosities of the intermediate compositions are increasing in compositions having pH 4.3 and pH 5.3. However, the increase is only moderate. Viscosity of intermediate composition having pH 3.3 is quite stable. Similar trend is observable in regard of the Cl content of the intermediate compositions.

TABLE 8
Characteristic of intermediate compositions of Example 6.

Intermediate Composition

| | 6-1 | 6-2 | 6-3 |
|---|---|---|---|
| Formic acid, g | 8 | 8 | 8 |
| Sulfuric acid, g | 61 | 78 | 104 |
| pH | 5.3 | 4.3 | 3.3 |
| Viscosity, cP | 278 | 237 | 230 |
| CI content, weight-% | 1.2 | 1.2 | 1.2 |

TABLE 9
Results of stability test of Example 6

| | Intermediate 6-1 | | Intermediate 6-2 | | Intermediate 6-3 | |
|---|---|---|---|---|---|---|
| Storage | pH 5.3 | | pH 4.3 | | pH 3.3 | |
| time | Viscosity | Cl content | Viscosity | Cl-content | Viscosity | Cl content |
| [days] | [cP] | [weight-%] | [cP] | [weight-%] | [cP] | [weight-%] |
| 0 | 278 | 1.2 | 237 | 1.2 | 230 | 1.2 |
| 7 | 270 | 1.6 | 229 | 1.3 | 185 | 1.2 |
| 14 | 284 | 1.8 | 241 | 1.4 | 187 | 1.2 |
| 21 | 318 | 1.9 | 255 | 1.5 | 193 | 1.2 |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. An intermediate composition in form of an aqueous solution having a pH value ≤6 for manufacture of polyamidoamine epihalohydrin resin, which intermediate composition comprises a polyamidoamine derivative having an average molecular weight of <150 000 g/mol with covalently bound pendant halohydrin groups, wherein the polyamidoamine derivative comprises 5-95 mol-%, preferably 7-90 mol-% of pendant halohydrin groups, and wherein the intermediate composition comprises a total amount of 1,3-dihalo-2-propanol and 3-halopropyleneglycol less than 3500 ppm, calculated from the total dry weight of the intermediate composition.

2. The intermediate composition according to claim 1, wherein the polyamidoamine derivative has a weight average molecular weight of <100 000 g/mol, preferably <50 000 g/mol, more preferably <35 000 g/mol.

3. The intermediate composition according to claim 1, wherein the intermediate composition has a pH value ≤5.5, preferably ≤5, more preferably ≤4.5, even more preferably ≤4.0.

4. The intermediate composition according to claim 1, wherein the polyamidoamine derivative comprises 30-95 mol-%, preferably 35-90 mol-%, more preferably 40-80 mol-%, of pendant halohydrin groups.

5. The intermediate composition according to claim 1, wherein the polyamidoamine derivative comprises 5-50 mol-%, preferably 7-40 mol-%, more preferably 10-35 mol-%, of pendant halohydrin groups.

6. The intermediate composition according to claim 5, wherein the polyamidoamine derivative comprises 50-95 mol-%, preferably 60-93 mol-%, more preferably 65-90 mol-%, of pendant azetidinium groups.

7. The intermediate composition according to claim 1, wherein the total amount of 1,3-dihalo-2-propanol and 3-halopropyleneglycol is less than 2000 ppm, preferably less than 1000 ppm, more preferably less than 700 ppm, even more preferably less than 500 ppm, calculated from the total dry weight of the intermediate composition.

8. The intermediate composition according to claim 1, wherein the intermediate composition comprises epihalohydrin and residuals originating from epihalohydrin less than 2000 ppm, preferably less than 1000 ppm, more preferably less than 700 ppm, even more preferably less than 500 ppm, calculated from the total dry weight of the intermediate composition.

9. The intermediate composition according to claim 1, wherein the intermediate composition has a polyamidoamine derivative content of 20-75 weight-%, preferably 25-65 weight-%, more preferably 30-60 weight-%.

10. The intermediate composition according to claim 1, wherein the intermediate composition has a halogen ion content <5 weight-%, preferably <3.5 weight-%, more preferably <3.0 weight-%, even more preferably <2.5 weight-%, calculated from the total dry weight of the intermediate composition.

11. The intermediate composition according to claim 1, wherein the intermediate composition has a viscosity in a range of 10-1000 mPas, preferably 50-500 mPas.

12. The intermediate composition according to claim 1, wherein the intermediate composition is obtained by reacting a polyamidoamine and epihalohydrin at a temperature <30° C., preferably ≤25° C., more preferably ≤20° C.

13. The intermediate composition according to claim 1, wherein that the intermediate composition is purified, e.g. by precipitation or filtration.

14. A method of manufacturing polyamidoamine epihalohydrin resin, wherein the method comprises the intermediate composition of claim 1.

15. A method for preparing an intermediate composition for manufacture of polyamidoamine epihalohydrin resin according to claim 1, the method comprising:
obtaining a polyamidoamine prepolymer by a condensation reaction of a dibasic carboxylic acid and a polyamine, such as a polyalkylenepolyamine,
reacting the obtained polyamidoamine prepolymer with epihalohydrin at a temperature of <30° C. in a presence of water to obtain the intermediate composition comprising a polyamidoamine derivative having an average molecular weight of <150 000 g/mol with covalently bound pendant halohydrin groups, wherein the polyamidoamine derivative comprises 5-95 mol-%, preferably 7-90 mol-% of pendant halohydrin groups, and
optionally purifying the intermediate composition, e.g. by precipitation or filtration.

16. The method according to claim 15, wherein the condensation reaction is performed at a temperature in a range from 120-170° C., preferably 130-150° C., at atmospheric pressure.

17. The method according to claim 15, wherein the molar ratio of dicarboxylic acid and polyamine is from 1:0.95 to 1:1.1, preferably from 1:1 to 1:1.1.

18. The method according to claim 15, wherein the obtained polyamidoamine prepolymer is reacted with epihalohydrin at the temperature of <25° C., more preferably ≤20° C., sometimes even <15° C.

19. The method according to claim 15, wherein the ratio of the obtained polyamidoamine and epihalohydrin, in weight-%, is from 66:34 to 70:30.

20. The method according to claim 15, wherein adjusting the pH value of the intermediate composition to pH ≤6, preferably ≤5.5, more preferably ≤5, even more preferably ≤4.5.
